(19) United States
(12) Patent Application Publication
(10) Pub. No.: US 2023/0200355 A1
(43) Pub. Date: Jun. 29, 2023

(54) Systems, Devices, and/or Methods for Managing Pets

(71) Applicant: Athena Corbin, Worcester, MA (US)

(72) Inventor: Athena Corbin, Worcester, MA (US)

(21) Appl. No.: 17/565,046

(22) Filed: Dec. 29, 2021

(51) Int. Cl. A01K 27/00

(52) U.S. Cl. CPC A01K 27/004; A01K 27/005

(57) ABSTRACT

Certain exemplary embodiments can provide a system, which comprises a first leash handle and a second leash handle. The first leash handle comprises a first pulley and a first retractable belt. The first leash handle comprising a first weighted portion that adds at least 400 grams to a weight of the first leash handle, first pulley, and first belt without the weighted portion. The second leash handle comprises a second pulley and a second retractable belt. The second leash handle comprising a second weighted portion that adds at least 400 grams to a weight of the second leash handle, second pulley, and second belt without the weighted portion.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a plan view of an exemplary embodiment of a system 1000;

FIG. 2 is a perspective view of an exemplary embodiment of a system 2000;

FIG. 3 is a perspective view of an exemplary embodiment of a system 3000;

FIG. 4 is a plan view of an exemplary embodiment of a system 4000;

FIG. 5 is a perspective view of an exemplary embodiment of a system 5000;

FIG. 6 is a perspective view of an exemplary embodiment of a system 6000; and

FIG. 7 is a plan view of an exemplary embodiment of a weighted leash handle 7000.

### DETAILED DESCRIPTION

Certain exemplary embodiments allow a user to combine exercise with dog walking. Using a single handle to walk one or more dogs does not allow for even exercise for both arms of a user. Exercise is improved via utilization of weighted handles. Weights allow for resistance exercise of the user in hand and arm muscles. Leash handles are constructed at a predetermined weight, which weight is selectable by the user to accomplish desired exercise goals. Users can perform arm and upper body toning. Such toning can result from a user performing curling motions with their arms while holding two handles, which provides weight resistant exercise to muscles such as bicep and/or tricep muscles.

Certain exemplary embodiments can provide a system, which comprises a first leash handle and a second leash handle. The first leash handle comprises a first pulley and a first retractable belt. The first leash handle comprising a first weighted portion that adds at least 400 grams to a weight of the first leash handle, first pulley, and first belt without the weighted portion. The second leash handle comprises a second pulley and a second retractable belt. The second leash handle comprising a second weighted portion that adds at least 400 grams to a weight of the second leash handle, second pulley, and second belt without the weighted portion.

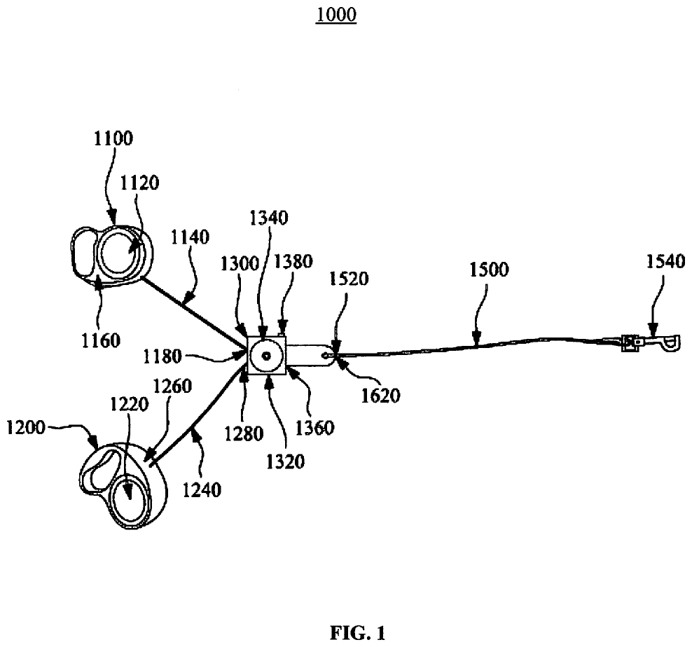

FIG. 1 is a plan view of an exemplary embodiment of a system 1000. System 1000 comprises a first leash handle 1100, a second leash handle 1200, a leash coupler 1300, and a fourth belt 1500.

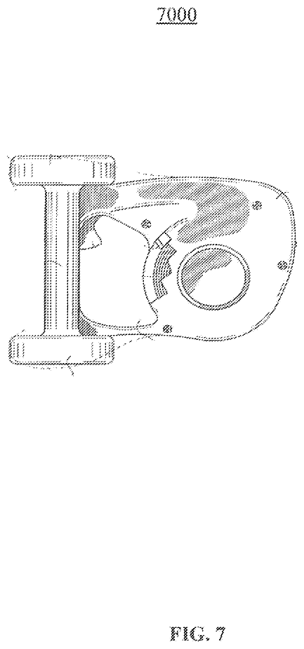

First leash handle 1100 comprises a first pulley 1120 and a first retractable belt 1140. First retractable belt 1140 is reversibly extendable via first pulley 1120. In certain exemplary embodiments, first leash handle 1100 comprises a first weighted portion 1160 that adds at least 400 grams to a weight of first leash handle 1100, first pulley 1120, and first retractable belt 1140 without first weighted portion 1160. In certain exemplary embodiments, first weighted portion 1160 of first leash handle 1100 can comprise a dumbbell shape and/or have a weighted handle (see, e.g., leash handle 7000 of FIG. 7).

In other exemplary embodiments, first leash handle 1100 lacks a weighted portion.

Second leash handle 1200 comprises a second pulley 1220 and a second retractable belt 1240. Second retractable belt 1240 is reversibly extendable via second pulley 1220. In certain exemplary embodiments, second leash handle 1200 comprises a second weighted portion 1260 that adds at least 400 grams to a weight of second leash handle 1200, second pulley 1220, and second retractable belt 1240 without second weighted portion 1260.

In other exemplary embodiments, second leash handle 1200 lacks a weighted portion.

In certain exemplary embodiments first weighted portion 1160 and/or second weighted portion 1260 can utilize a metal portion with a rubber overlay to provide a desired weight.

Leash coupler 1300 can comprise:
a base 1320 that receives and is coupled to a first end 1180 of first retractable belt 1140 and a second end 1280 of second retractable belt 1240;
a third pulley 1340 coupled to base 1320, the third pulley comprising a third belt 1360; and
a clip 1520.

In certain exemplary embodiments, clip 1520 is coupled to a fourth belt 1500. In such embodiments, fourth belt 1500 comprises a third end 1620 and a fourth end 1540.

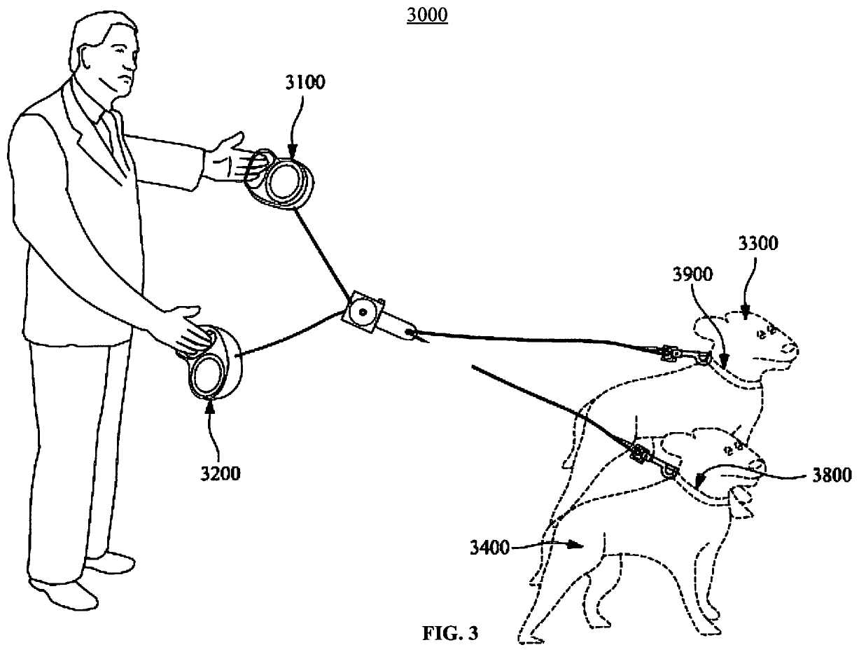

Certain exemplary embodiments lack clip 1520 and fourth belt 1500. In such embodiments, third belt 1360 is coupled to a dog collar (see first pet collar 3800 of FIG. 3).

In certain exemplary embodiments, third pulley 1340 comprises a pulley. In such embodiments, third belt 1360 can be extendable and retractable for added flexibility in walking pets.

Third pulley 1340 can comprise a push lock 1380, which can be used to improve safety and control. Third pulley 1340 can be coupled to clip 1520 and third end 1620

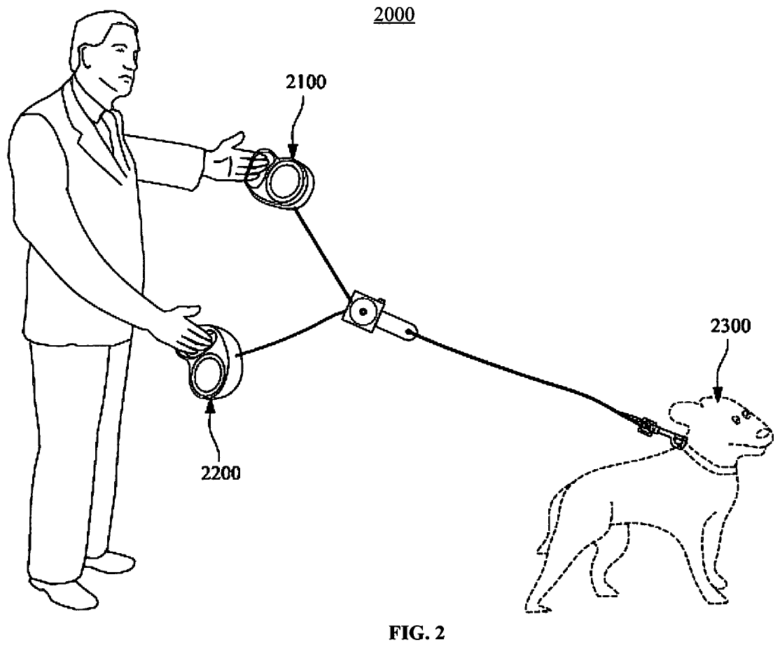

FIG. 2 is a perspective view of an exemplary embodiment of a system 2000, which illustrates a first leash handle 2100 and a second leash handle 2200 coupled to a single dog 2300.

FIG. 3 is a perspective view of an exemplary embodiment of a system 3000, which illustrates a first leash handle 3100 and a second leash handle 3200 coupled to a first dog 3300 via first pet collar 3800 and a second dog 3400 via second pet collar 3900. Certain exemplary embodiments can comprise additional belts to allow walking any count of dogs utilizing first leash handle 3100 and second leash handle 3200.

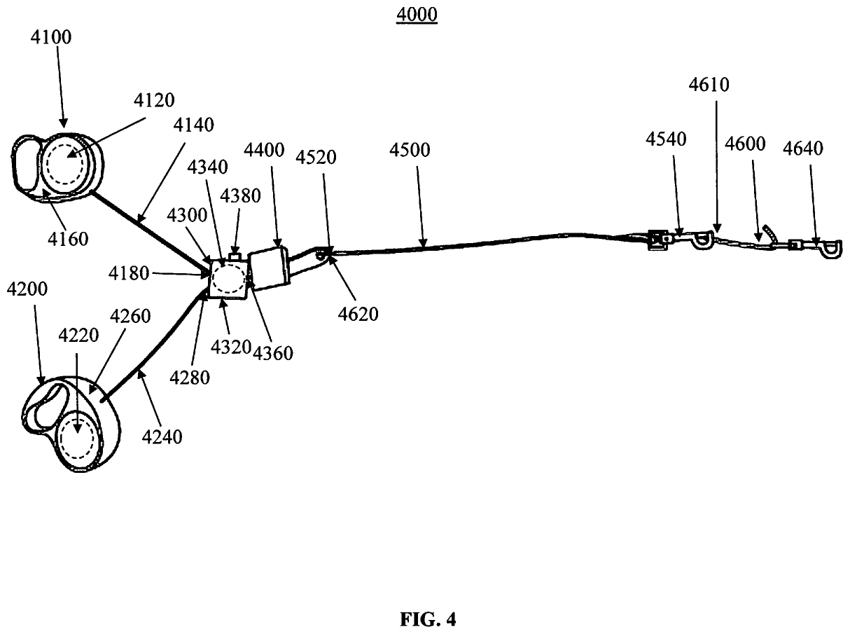

FIG. 4 is a plan view of an exemplary embodiment of a system 4000. System 4000 comprises a first leash handle 4100, a second leash handle 4200, a leash coupler 4300, and a fourth belt 4500.

First leash handle 4100 comprises a first pulley 4120 and a first retractable belt 4140. First retractable belt 4140 is reversibly extendable via first pulley 4120. First leash handle 4100 comprises a first weighted portion 4160 that adds at least 400 grams to a weight of first leash handle 4100, first pulley 4120, and first retractable belt 4140 without first weighted portion 4160. In certain exemplary embodiments, first weighted portion 4160 of first leash handle 4100 can comprise a dumbbell shape and/or have a weighted handle (see, e.g., leash handle 7000 of FIG. 7).

Second leash handle 4200 comprises a second pulley 4220 and a second retractable belt 4240. Second retractable belt 4240 is reversibly extendable via second pulley 4220. Second leash handle 4200 comprises a second weighted portion 4260 that adds at least 400 grams to a weight of second leash handle 4200, second pulley 4220, and second retractable belt 4240 without second weighted portion 4260.

In certain exemplary embodiments first weighted portion 4160 and/or second weighted portion 4260 can utilize a metal portion with a rubber overlay to provide a desired weight.

Leash coupler 4300 can comprise:
a base 4320 that receives and is coupled to a first end 4180 of first retractable belt 4140 and a second end 4280 of second retractable belt 4240;
a third pulley 4340 coupled to base 4320, third pulley 4340 comprising a third belt 4360; and
a clip 4520.

Certain exemplary embodiments comprise a fifth belt 4600, the fifth belt comprising a fifth end 4610 and a sixth end 4640.

Third pulley 4340 can comprise a push lock 4380, which can be used to improve safety and control. Third pulley 4340 can be coupled to clip 4520 and fifth end 4620

Fourth belt 4500 comprises a third end 4620 and a fourth end 4540. Third end 4620 of fourth belt 4500 is coupleable to clip 4400. Fourth end 4540 of fourth belt 4500 is coupleable to a first pet collar (see first pet collar 3800 of FIG. 3).

In certain exemplary embodiments, third pulley 4340 can comprise a pulley. In such embodiments, third belt 4360 can be extendable and retractable for added flexibility in walking pets.

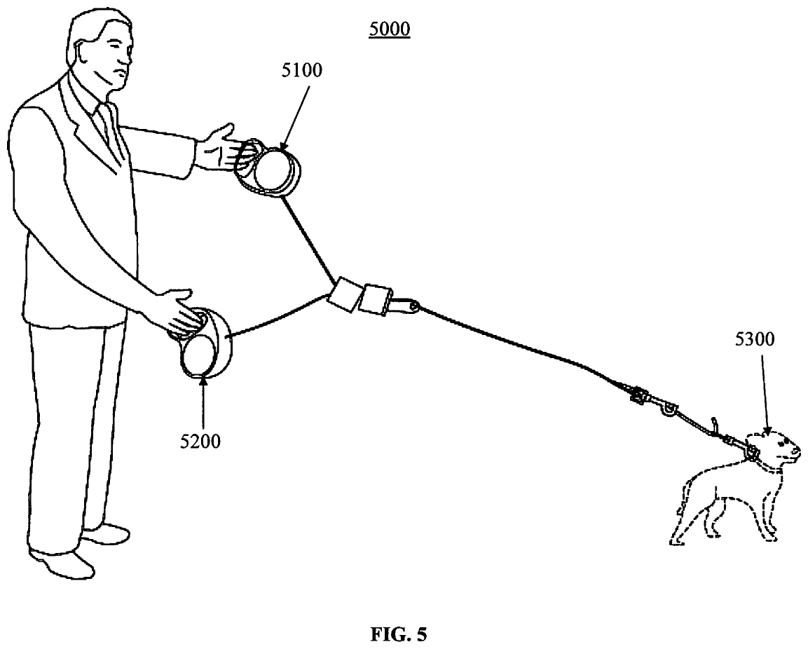

FIG. 5 is a perspective view of an exemplary embodiment of a system 5000, which illustrates a first leash handle 5100 and a second leash handle 5200 coupled to a single dog 5300.

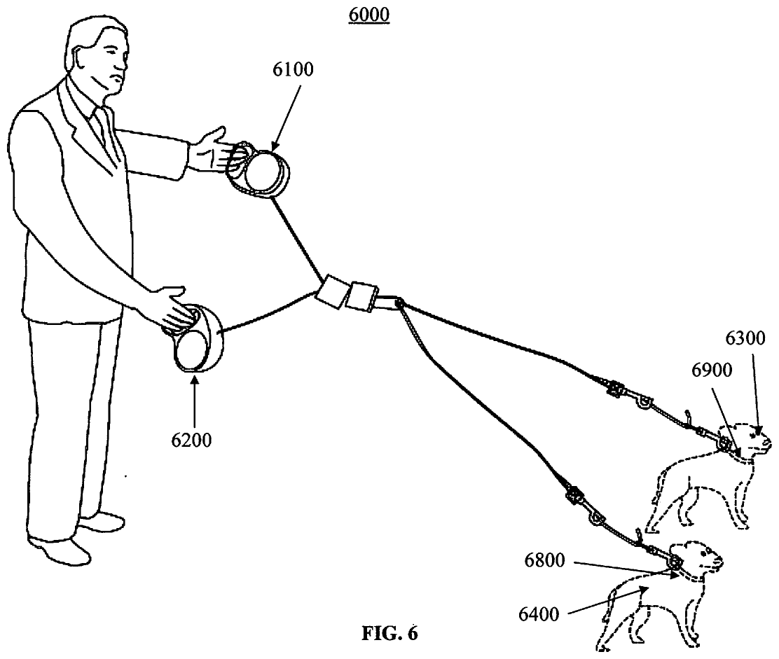

FIG. 6 is a perspective view of an exemplary embodiment of a system 6000, which illustrates a first leash handle 6100 and a second leash handle 6200 coupled to a first dog 6300 via first pet collar 6800 and a second dog 6400 via second pet collar 6900. Certain exemplary embodiments can comprise additional belts to allow walking any count of dogs utilizing first leash handle 6100 and second leash handle 6200.

FIG. 7 is a plan view of an exemplary embodiment of a weighted leash handle 7000.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapted to—made suitable or fit for a specific use or situation.
adapter—a device used to effect operative compatibility between different parts of one or more pieces of an apparatus or system.
and/or—either in conjunction with or in alternative to.
apparatus—an appliance or device for a particular purpose
associate—to join, connect together, and/or relate.
base—a supporting portion of something.
can—is capable of, in at least some embodiments.
cause—to produce an effect.
clip—a device that is coupleable to a belt.
comprising—including but not limited to.
configure—to make suitable or fit for a specific use or situation.
connect—to join or fasten together.
constructed to—made to and/or designed to.
convert—to transform, adapt, and/or change.
coupleable—capable of being joined, connected, and/or linked together.
coupler—a component that is directly linkable to something.
coupling—linking in some fashion.
create—to bring into being.
define—to establish the outline, form, or structure of
device—a machine, manufacture, and/or collection thereof.
dumbbell—a bar with weights at each end.
end—a most extreme part of an object.
extendable—capable of being expanded in length by unraveling a wound pulley.
gram—a metric unit of mass equal to 0.001 kilogram and nearly equal to the mass of one cubic centimeter of water at its maximum density.
handle—a part of a thing sized and/or shaped specifically to be grasped or held by a hand of a user.
install—to connect or set in position and prepare for use.
leash—a device that comprises a rope or similar material used to control an animal by attaching it to a collar, harness, or halter.
lock— (n) a component that fastens something in a fixed position; (v) to fasten.
may—is allowed and/or permitted to, in at least some embodiments.
method—a process, procedure, and/or collection of related activities for accomplishing something.
pet collar—a band, strip, or chain worn around a neck of an animal.
plurality—the state of being plural and/or more than one.
predetermined—established in advance.
provide—to furnish, supply, give, and/or make available.
pulley—a wheel on an axle or shaft that is designed to support movement and change of direction of a belt.
push lock—a lock that restrains a belt from moving about a pulley, the lock is set by pressing a button or lever.
receive—to get, take, acquire, and/or obtain.
retractable—capable of being repeatedly extended and pulled back after being extended.
reversibly—capable of being nondestructively extended and retracted.
set—a related plurality.
store—to place, hold, and/or retain.
substantially—to a great extent or degree.
support—to bear the weight of, especially from below.
system—a collection of mechanisms, devices, machines, articles of manufacture, processes, data, and/or instructions, the collection designed to perform one or more specific functions.
transmit—to send, provide, furnish, and/or supply.
via—by way of and/or utilizing.
weight—the force with which a body is attracted toward Earth, equal to the product of the object's mass and the acceleration of gravity.
weighted—made heavier by adding a component.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a first leash handle, the first leash handle comprising a first pulley and a first retractable belt, the first retractable belt reversibly extendable via the first pulley, the first leash handle comprising a first weighted portion that adds at least 400 grams to a weight of the first leash handle, the first pulley, and the first retractable belt without the first weighted portion;
a second leash handle, the second leash handle comprising a second pulley and a second retractable belt, the second retractable belt reversibly extendable via the second pulley, the second leash handle comprising a second weighted portion that adds at least 400 grams to a weight of the second leash handle, the second pulley, and the second retractable belt without the second weighted portion,
a leash coupler, the leash coupler comprising:
a base that receives and is coupled to a first end of the first retractable belt and a second end of the second retractable belt;
a third pulley, the third pulley coupled to the base; and
a clip, the clip coupled to a third belt, the third belt coupleable to a first pet collar.

2. The system of claim 1, further comprising:
a fourth belt, the fourth belt comprising a third end and a fourth end, the third end of the fourth belt coupleable to the clip, the fourth end of the fourth belt coupleable to the first pet collar.

3. The system of claim 1, further comprising:
a fourth belt, the fourth belt comprising a third end and a fourth end, the third end of the fourth belt coupleable to the clip, the fourth end of the fourth belt coupleable to the first pet collar; and
a fifth belt, the fifth belt comprising a fifth end and a sixth end, the fifth end of the fifth belt coupleable to the clip, the sixth end of the fifth belt coupleable to a second pet collar.

4. The system of claim 1, wherein:
the third pulley comprises a push lock, the push lock constructed to fix a length of the third belt.

5. The system of claim 1, wherein:
the first weighted portion of the first leash handle has a dumbbell shape.

6. A system comprising:
a first leash handle, the first leash handle comprising a first pulley and a first retractable belt, the first retractable belt reversibly extendable via the first pulley, the first leash handle comprising a weighted portion that adds at least 400 grams to a weight of the first leash handle, the first pulley, and the first belt without the weighted portion;
a second leash handle, the second leash handle comprising a second pulley and a second retractable belt, the second retractable belt reversibly extendable via the second pulley, the second leash handle comprising a weighted portion that adds at least 400 grams to a weight of the second leash handle, the second pulley, and the second belt without the weighted portion,
a leash coupler, the leash coupler comprising a clip; and
a third belt, the third belt comprising a first end and a second end, the first end of the third belt coupleable to the clip, the second end of the third belt coupleable to a first pet collar.

7. The system of claim 6, further comprising:
a fourth belt, the fourth belt comprising a third end and a fourth end, the third end of the fourth belt coupleable to the clip, the fourth end of the fourth belt coupleable to a second pet collar.

8. A system comprising:
a first leash handle, the first leash handle comprising a first pulley and a first retractable belt, the first retractable belt reversibly extendable via the first pulley;
a second leash handle, the second leash handle comprising a second pulley and a second retractable belt, the second retractable belt reversibly extendable via the second pulley,
a leash coupler, the leash coupler comprising a clip; and
a third belt, the third belt comprising a first end and a second end, the first end of the third belt coupleable to the clip, the second end of the third belt coupleable to a first pet collar.
